(19) United States
(12) Patent Application Publication
(10) Pub. No.: US 2011/0148298 A1
(43) Pub. Date: Jun. 23, 2011

(54) LED LIGHTING TUBE ADOPTING ISOLATED FLUORESCENT CONVERSION TECHNOLOGY

(76) Inventors: BINGQIAN LI, Shenzhen (CN); Hongcun Peng, Shenzhen (CN); Weiguo Wang, Shenzhen (CN)

(21) Appl. No.: 12/942,989

(22) Filed: Nov. 9, 2010

(30) Foreign Application Priority Data
Dec. 18, 2009 (CN) 200910261117.4

(51) Int. Cl. H01J 13/46; H01K 1/62

(52) U.S. Cl. 315/35; 315/32

(57) ABSTRACT

An LED lighting tube includes a strip-shaped metal shell, a LED light source, a white light conversion film, and a driving power supply. The metal shell defines two spaced slots inwardly. The white light conversion film and the LED light source are respectively fixed in the two slots. The white light conversion film is isolated from the LED light source. The driving power supply is accommodated in the metal shell.

### BACKGROUND OF THE INVENTION

a) Field of the Invention

This invention relates to one light source, and specifically relates to a kind of LED lighting tube.

b) Description of the Prior Art

In recent years, the rapid development of white LED is gradually entering the field of common lighting. Compared with fluorescent lamp, LED lighting source has the features of long service life, high luminous efficiency, and low energy consumption. Furthermore, fluorescent tubes contain heavy metals like mercury and etc, and can not be recycled after the disuse under the conditions of the existing technology. Heavy metal materials generated by the cracked tube may harm the environment and human. Compared with the fluorescent lamp, LED lighting source can solve the problems of high energy consumption, short service life, and impact of heavy metals on the environment and human after the disuse.

Prior white LED lighting tube is manufactured by assembling packaged white LED devices onto a circuit board so that an integrated light source is formed. The main drawbacks of this technology are:

It is difficult to control the phosphor uniformity when coating a blue LED chip with phosphor powder, which leads to the poor brightness uniformity of the finished white LED products. It is also difficult to adjust the color temperature of white LED lamps after the finished products are formed. The phosphor directly contacts with the blue LED chip, and heat radiated by blue LED chip can result in the high operation temperature of the phosphor, which speed up the aging of the phosphor, and affect the service life of the entire white LED lamps.

A great deal of organic material is used on pathway of light beam radiation out of the lighting source, such as the lens of organic material, reflector cup of organic material. In the process of long-term use, the color change of organic material will seriously affect the luminous efficiency.

The sealed LED devices can form lots of dazzling light spots in the light source, which fails to suit people's habits. Addition of scattering components into the light-emitting surface partially overcomes dazzling problem caused by point light source. However, this technology can lead to a sharp decline of luminous efficiency of LED lighting tube and thus affect the promotion of the use of LED lighting tube.

### SUMMARY OF THE INVENTION

In view of drawbacks of prior technology, the purpose of the invention is to provide a kind of LED lighting tube to eliminate above drawbacks such as inefficiency of traditional fluorescent light, serious light attenuation and difficulty to control uniformity of light color, and dazzling of light-emitting light source of point light sources array, etc.

To achieve above purposes, an LED lighting tube according to the present invention includes a strip-shaped metal shell, a LED light source, a white light conversion film, and a driving power supply. The metal shell defines two spaced slots inwardly. The white light conversion film and the LED light source are respectively fixed in the two slots. The white light conversion film is isolated from the LED light source. The driving power supply is accommodated in the metal shell.

According to an embodiment of the present invention, two lamp holders are respectively connected to ends of the metal shell.

According to the embodiment of the present invention, the white light conversion film includes a carrier, and a white LED phosphor layer which is coated on the carrier by printing process.

According to the embodiment of the present invention, the LED light source includes a metal circuit board and a blue or purple, or UV LED chip array formed on the metal circuit board.

According to the embodiment of the present invention, a surface of the metal shell is configured with more than one convex edge for increasing the area of heat elimination.

According to the embodiment of the present invention, one or more protrusions are formed on the surface of the LED chip array by sealed colloid.

The phosphor layer of the white light conversion film is isolated from the LED chip array, which avoids the temperature of the phosphor heating up and the aging of the phosphor, thereby improves the service life of the LED lighting tube. The phosphor is uniformly disposed in the phosphor layer, thereby improving the brightness uniformity of the LED lighting tube. Furthermore, compared to traditional art, the LED lighting tube of the invention eliminates drawbacks such as the low efficiency and serious light attenuation, large internal optical loss, and poor uniformity light-emitting of existing LED light source, while gives full play with the energy-saving, environmentally-friendly features of LED lamps, and has the advantages of convenient use, good radiating, high light efficiency, small light attenuation, even light-emitting without glare, etc.

### BRIEF DESCRIPTION OF THE DRAWINGS

The present invention will be apparent to those skilled in the art by reading the following description when taken in conjunction with the accompanying drawings, in which:

FIG. 1 shows the overall structure of an LED lighting tube in accordance with a first embodiment of the invention;

FIG. 2 shows a cross-sectional view of the LED lighting tube shown in FIG. 1 of the invention;

FIG. 3 shows the structure diagram of an LED light source shown in FIG. 1 of the invention; and

FIG. 4 shows the structure diagram of an LED lighting tube in accordance with a second embodiment of the invention.

### DETAILED DESCRIPTION OF THE PREFERRED EMBODIMENT

The invention is described below in further detail in conjunction with the accompanying drawings and embodiments of the invention.

### Embodiment 1

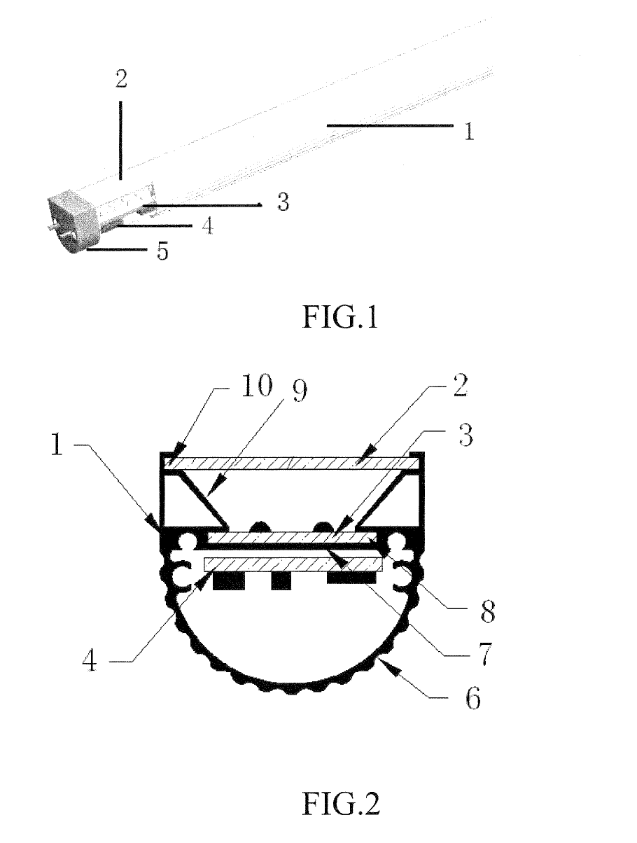

Referring to FIGS. 1 and 2, an LED lighting tube in accordance with a first embodiment of the invention includes a metal shell 1, a white light conversion film 2, a LED light source 3 for emitting blue or purple or UV (ultraviolet) light, a driving power supply 4, and holders 5. The metal shell 1 has a strip-shaped form. The metal shell 1 includes a thin board 7 whose edge contacting with an inner wall of the metal shell 1. The thin board 7 defines two slots 8 in both sides thereof; for fixing the LED light source 3. Each of two slopes 9 has a lower edge contacting with the thin board and an upper edge. The slopes 9 have a reflective layer on a surface thereof; for improving the luminous efficiency of LED lighting tube. Each of two receiving board (not label) has an edge contacting with the inner wall of the metal shell 1 and an opposite edge contacting with the upper edge of a corresponding slope 9. Each receiving board defines a slot 10. The two slots 10 corporately receive the white light conversion film 2. A surface of the metal shell 1 is configured with more than one convex edge for increasing the area of heat elimination.

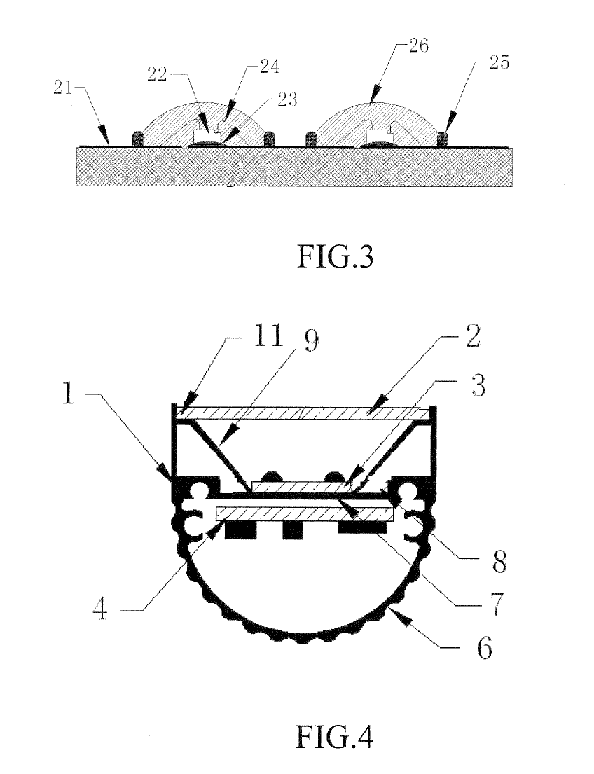

Referring to FIG. 3, the LED light source 3 includes a metal circuit board 21 and a blue or purple, or UV LED chip array 22 formed on the metal circuit board 21 by high thermal conductivity glue 23. The metal circuit board 21 and the thin board 7 are in close contact to facilitate the rapid transfer of heat form the LED chip array 22 to the metal shell 1. LED chips of the LED chip array 22 are electrically interconnected with each other in series and/or parallel. The LED chips are connected to the metal circuit board 21 via metal wires 24. Steps 25 are made on the periphery of the LED chips. Silica gel 26 is injected to the steps 25. Silica gel 26 is made into a hemispherical, spherical crown or other protruding shape to achieve high optical extraction efficiency.

White light conversion film 2 includes a carrier made of transparent glass material, and a white LED phosphor layer made of phosphor material. The phosphor layer is coated on the carrier by printing process. The phosphor layer of the white light conversion film 2 transforms the blue or purple or UV light emitted from the LED light source 3 into white light by the LED phosphor therein.

The driving power supply 4 is accommodated in the metal shell 1. Two lamp holders 5 are respectively connected to both ends of the metal shell. The structure and size of the holders 5 are similar to traditional fluorescent lamp.

### Embodiment 2

Referring to FIG. 4, an LED lighting tube in accordance with a second embodiment of the invention includes a metal shell 1, a white light conversion film 2, a LED light source 3 for emitting blue or purple or UV light, a driving power supply 4, and holders 5. The metal shell 1 has a strip-shaped form. The metal shell 1 includes a thin board 7 whose edge contacting with an inner wall of the metal shell 1. Each of two slopes 9 has a lower edge contacting with the thin board and an upper edge. The slopes 9 have a reflective layer on a surface thereof, for improving the luminous efficiency of LED lighting tube. Each of two receiving board 11 has an edge contacting with the inner wall of the metal shell 1 and an opposite edge contacting with the upper edge of a corresponding slope 9. A surface of the metal shell 1 is configured with more than one convex edge for increasing the area of heat elimination.

The white light conversion film 2 is fixed to the thin board 7 via adhesive. The LED light source 3 is fixed to the receiving board 11 via the thermal conductive adhesive.

As mentioned above, the phosphor layer of the white light conversion film 2 is isolated from the LED chip array 22, which avoids the temperature of the phosphor heating up and the aging of the phosphor, thereby improves the service life of the LED lighting tube. The phosphor is uniformly disposed in the phosphor layer, thereby improving the brightness uniformity of the LED lighting tube. Furthermore, compared to traditional art, the LED lighting tube of the invention eliminates drawbacks such as the low efficiency and serious light attenuation, and large internal optical loss, and poor uniformity light-emitting of existing LED light source, while gives full play with the energy-saving, environmentally-friendly features of LED lamps, and has the advantages of convenient use, good radiating, high light efficiency, small light attenuation, even light-emitting without glare, etc.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

I claim:

1. An LED lighting tube comprising:
a metal shell, configured in a strip-shaped form, defining two spaced slots inwardly;
a white light conversion film and an LED light source, respectively fixing in the two slots, the white light conversion film being isolated from the LED light source; and
a driving power supply accommodated in the metal shell.

2. The LED lighting tube according to claim 1, further comprises two lamp holders respectively connected to both ends of the metal shell.

3. The LED lighting tube according to claim 1, wherein the white light conversion film includes a carrier, and a white LED phosphor layer which is coated on the carrier by printing process.

4. The LED lighting tube according to claim 1, wherein the LED light source includes a metal circuit board and a blue or puiple, or UV LED chip array formed on the metal circuit board.

5. The LED lighting tube according to claim 1, wherein a surface of the metal shell is configured with more than one convex edge for increasing the area of heat elimination.

6. The LED lighting tube according to claim 4, wherein one or more protrusions is formed on the surface of the LED chip array by sealed colloid.

7. An LED lighting tube comprising:
a metal shell in a strip-shaped form including a thin board whose edge contacting with an inner wall of the metal shell;
two slopes, each having a lower edge contacting with the thin board and an upper edge;
two receiving board, each having an edge contacting with the inner wall of the metal shell and an opposite edge contacting with the upper edge of a corresponding slope;
an LED light source being disposed on the thin board, for emitting blue or purple or UV light;
a white light conversion film being disposed on the receiving board, for transform the blue or purple or UV light into white light; and
a driving power supply accommodated in the metal shell.

8. The LED lighting tube according to claim 7, further comprises two lamp holders respectively connected to both ends of the metal shell.

9. The LED lighting tube according to claim 7, wherein the white light conversion film is fixed to the thin board via adhesive, and the LED light source is fixed to the receiving board via the thermal conductive adhesive.

10. The LED lighting tube according to claim 7, wherein each receiving board defines a first slot, the two slot corporately receiving the white light conversion film.

11. The LED lighting tube according to claim 7, wherein the thin board defines a second slot for receiving the LED light source.

12. The LED lighting tube according to claim 7, wherein the white light conversion film includes a carrier, and a white LED phosphor layer which is coated on the carrier by printing process.

13. The LED lighting tube according to claim 7, wherein the LED light source includes a metal circuit board and a blue or purple, or UV LED chip array formed on the metal circuit board.

14. The LED lighting tube according to claim 7, wherein the slopes have a reflective layer on a surface thereof, for improving the luminous efficiency of LED lighting tube.

15. The LED lighting tube according to claim 7, wherein a surface of the metal shell is configured with more than one convex edge for increasing the area of heat elimination.

16. The LED lighting tube according to claim 13, wherein one or more protrusions is formed on the surface of the LED chip array by sealed colloid.
